(19) United States
(12) Patent Application Publication
(10) Pub. No.: US 2018/0330002 A1
(43) Pub. Date: Nov. 15, 2018

(54) Service Processing Method, and Data Processing Method and Apparatus

(71) Applicant: Alibaba Group Holding Limited, Grand Cayman (KY)

(72) Inventor: Yuxiang Hu, Hangzhou (CN)

(21) Appl. No.: 16/046,894

(22) Filed: Jul. 26, 2018

Related U.S. Application Data
(63) Continuation of application No. PCT/CN2017/071409, filed on Jan. 17, 2017.

(30) Foreign Application Priority Data
Jan. 27, 2016 (CN) 201610055298.5

(51) Int. Cl. G06F 17/30

(52) U.S. Cl. CPC G06F 17/30867; G06F 17/30598; G06F 17/30303

(57) ABSTRACT

A service processing method, a data processing method, and apparatuses thereof are provided. The service processing method includes determining a target resource category to which a network resource to be processed belongs; acquiring target news information that matches the target resource category; and performing service processing on the network resource to be processed according to the target news information. The present disclosure provides a new service processing method, which can improve the quality of service processing and enrich ways of service processing.

### CROSS REFERENCE TO RELATED PATENT APPLICATIONS

This application claims priority to and is a continuation of PCT Patent Application No. PCT/CN2017/071409 filed on 17 Jan. 2017, and is related to and claims priority to Chinese Patent Application No. 201610055298.5, filed on 27 Jan. 2016, entitled “Service Processing Method, and Data Processing Method and Apparatus,” which are hereby incorporated by reference in their entirety.

### TECHNICAL FIELD

The present disclosure relates to the technical field of the Internet, and particularly to service processing methods, and data processing methods and apparatuses.

### BACKGROUND

With the development of Internet technology, network resources are increasing, and services that rely on the network resources are also growing, for example, information push related to the network resources, upload/download of the network resources, and acquisition of the network resources, and management of the network resources, etc.

An existing process of service processing mainly depends on attribute information of a network resource. In some situations, the service processing may be affected by information from an external world. For example, in the area of e-commerce, sales volumes of some commodities tend to be affected by hot news and information. Therefore, existing service processing methods are relatively simple, with poor processing effects. Therefore, a new service processing method is needed.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Various aspects of the present disclosure provide a service processing method, and a data processing method and an apparatus thereof, to provide new service processing methods, improve the quality of service processing, and enrich service processing methods.

In implementations, a service processing method is provided, which includes determining a target resource category to which a network resource to be processed belongs; acquiring target news information that matches the target resource category; and performing service processing on the network resource to be processed according to the target news information.

In implementations, a data processing method is provided, which includes capturing news information meeting a preset requirement from a network platform according to a preset capturing period; calculating a respective degree of similarity between the news information and each resource category in a resource category library; determining a resource category having a degree of similarity with the news information that meets a first preset similarity condition; and establishing a matching relationship between the news information and the determined resource category.

In implementations, a service processing method is provided, which includes capturing news information meeting a preset requirement from a network platform according to a preset capturing period; determining a target resource category that matches the news information; and performing service processing on a network resource under the target resource category.

In implementations, a service processing apparatus is provided, which includes a first determination module configured to determine a target resource category to which a network resource to be processed belongs; an acquisition module configured to obtain target news information that matches the target resource category; and a service module configured to perform service processing on the network resource to be processed according to the target news information.

In implementations, a data processing apparatus is provided, which includes a capturing module configured to capture news information meeting a preset requirement from a network platform according to a preset capturing period; a calculation module configured to calculate a respective degree of similarity between the news information and each resource category in a resource category library; a determination module configured to determine a resource category having a degree of similarity with the news information that meets a first preset similarity condition; and an establishing module configured to establish a matching relationship between the news information and the determined resource category.

In implementations, a service processing apparatus is provided, which includes a capturing module configured to capture news information meeting a preset requirement from a network platform according to a preset capturing period; a determination module configured to determine a target resource category that matches the news information; and a service module configured to perform service processing on a network resource under the target resource category.

In implementations, a target resource category to which a network resource to be processed belongs is determined, and target news information that matches the target resource category is obtained. Service processing is performed on the network resource to be processed according to the target news information. Alternatively, news information is captured, and a target resource category that matches the news information is determined. Service processing is performed based on the target resource category to provide a service processing method based on matching relationships between news information and resource categories, thus fully exerting an impact of news information on a process of service processing, improving an accuracy of service processing, while enriching the service processing method.

### BRIEF DESCRIPTION OF THE DRAWINGS

In order to more clearly describe technical solutions in the embodiments of the present disclosure, drawings to be used in the description of the embodiments are briefly described herein. Apparently, the described drawings represent some embodiments of the present disclosure. One skilled in the art can also obtain other drawings based on these drawings without making any creative effort.

FIG. 1 is a flowchart of a service processing method provided by an embodiment of the present disclosure.

FIG. 2A is a flowchart of a service processing method provided by another embodiment of the present disclosure.

FIGS. 2B and 2C are schematic diagrams of system structures used for implementing the method as shown in FIG. 2A provided by another embodiment of the present disclosure.

FIG. 2D is a schematic diagram of an exemplary relationship between news information and a resource category in accordance with another embodiment of the present disclosure.

FIG. 3 is a flowchart of a service processing method provided by another embodiment of the present disclosure.

FIG. 4 is a schematic structural diagram of a service processing apparatus provided by another embodiment of the present disclosure.

FIG. 5 is a schematic structural diagram of a service processing apparatus provided by another embodiment of the present disclosure.

FIG. 6 is a schematic structural diagram of a data processing apparatus provided by another embodiment of the present disclosure.

FIG. 7 is a schematic structural diagram of a data processing apparatus provided by another embodiment of the present disclosure.

FIG. 8 is a schematic structural diagram of a service processing apparatus provided by another embodiment of the present disclosure.

### DETAILED DESCRIPTION

To make the objectives, technical solutions, and advantages of the embodiments of the present disclosure more clear, the technical solutions in the embodiments of the present disclosure are described in a clear and complete manner with reference to the accompanying drawings in the embodiments of the present disclosure. Apparently, the described embodiments represent some and not all of the embodiments of the present disclosure. All other embodiments obtained by one of ordinary skill in the art based on the embodiments of the present disclosure without making creative efforts shall fall within the scope of protection of the present disclosure.

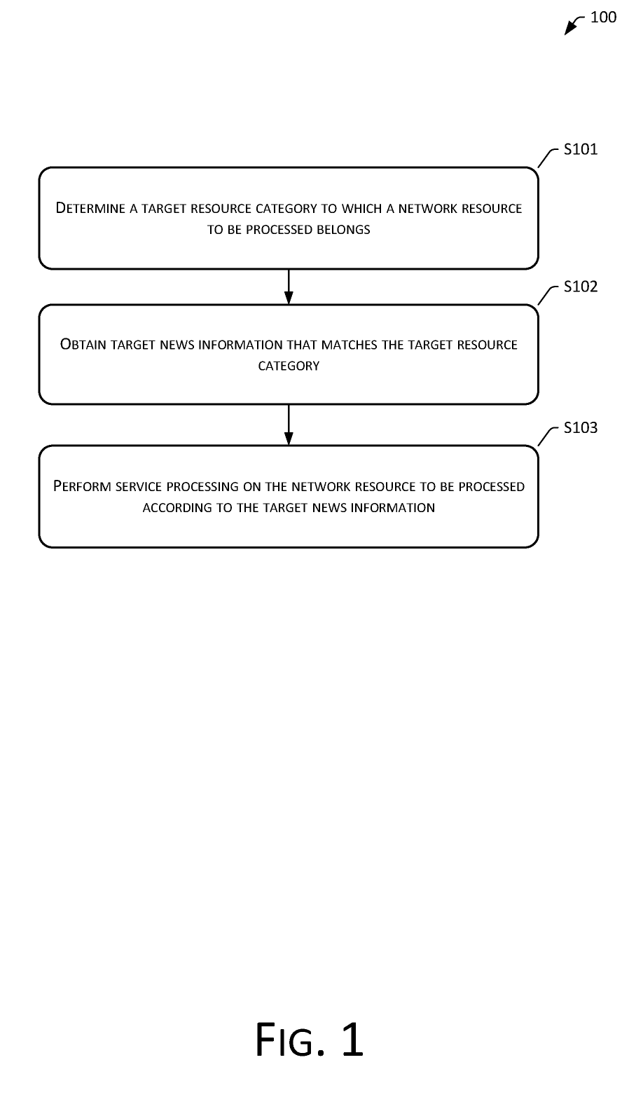

FIG. 1 is a flowchart of a service processing method 100 provided by an embodiment of the present disclosure. As shown in FIG. 1, the method includes the following operations.

S101: Determine a target resource category to which a network resource to be processed belongs.

S102: Obtain target news information that matches the target resource category.

S103: Perform service processing on the network resource to be processed according to the target news information.

The present embodiment provides a service processing method that can be executed by a service processing apparatus to implement a new process of service processing, thus improving the quality of service processing, and enriching service processing methods.

After analysis and research of the inventors of the present disclosure, news information is found to be closely related to network resources and services that rely on the network resources. A most direct discovery of the inventors of the present disclosure is that the sales of some commodities are often affected by hot news and information in the field of e-commerce. For example, the recent hot news related to the Tianjin bombings triggered people to pay attention to fire safety and environmental pollution, thereby boosting the sales volumes of such products as fire extinguishers, masks, and disinfecting water, etc. The hot news about “Chai Jing's speech ‘Under the dome’” triggered people to pay attention to air quality around them, and thereby led to an increase in the sales of anti-haze masks and other commodities. The hot news of “Chengdu female driver was beaten” that mentioned a driving recorder caused everyone to pay attention to driving recorders, and products related to driving recorders also hit a sales peak.

Based on the above considerations, the inventors of the present disclosure provide a new service processing method. A main principle thereof is to perform service processing based on a matching relationship between a resource category and news information. A service processing method provided by the present disclosure involves news information, service processing, and network resources. For the sake of description, a network resource involved in the service processing method of the present disclosure is called a network resource to be processed, a resource category to which a network resource belongs is called a target resource category, and news information that matches a target resource category is called target news information.

First, the embodiments of the present disclosure do not have any limitations on the content of news information, which may include, for example, at least one of a news event, a hot topic, a character trend, product information, or the like. In addition, an implementation format of news information is also not limited, which may include, for example, at least one of a text, a picture, a video, or the like.

In addition, a resource category in the embodiments of the present disclosure refers to a category to which a network resource belongs. The embodiments of the present disclosure do not have any limitations on a type of a network resource. In different application scenarios, network resources will be different, and categories of the network resources will also be different. For example:

In the field of e-commerce, network resources can be various types of commodities and services provided by sellers. Correspondingly, resource categories can be categories to which the network resources belong, such as women's wear, men's wear, shoes, life, learning, sports, outdoor, and maternal and child care, etc. It should be noted that the embodiments of the present disclosure do not have any limitations on category levels. In other words, in the embodiments of the present disclosure, resource categories may include categories of various levels.

Based on the above introduction, a service processing method of the present embodiment specifically includes:

A resource category to which a network resource to be processed belongs is determined as a target resource category. News information matching the target resource category is then obtained as target news information. Service processing is then performed on the network resource to be processed according to the target news information.

It should be noted that specific processes of service processing for network resources to be processed according to target news information are different based on different application scenarios. Some service scenarios in the field of e-commerce are used herein as examples for illustration. On a basis of the description of the following examples, one skilled in the art can implement processes of service processing for network resources according to target news information in other application scenarios.

In the field of e-commerce, an e-commerce platform recommending products to users (where users can be either Type B users or Type C users) is a relatively common service scenario. As popular news and information may affect prices and popularities of the products, the method provided in the present embodiment may be used to recommend some products related to the popular news and information to a user. The type B users herein refer to users in a category B trade scenario. Such users purchase products not for their own consumption, but for trading again, such as selling or processing. The C-type users herein refer to users in a C-type trade scenario. Such users are ordinary consumers, and their purchases of products are mainly used for their own consumption. Specifically, a category to which a product to be recommended belongs is determined as a target category, and news information that matches the target category is obtained as target news information. Recommendation processing is performed on the product to be recommended according to the target news information.

Performing recommendation processing on the product to be recommended according to the target news information includes, but is not limited to, the following processing.

According to the target news information, a determination is made as to whether the product to be recommended has a recommendation value, i.e., determining whether to recommend the product to be recommended to a user. For example, a category to which an anti-haze mask belongs matches the hot news related to “Chai Jing's speech of ‘under the dome’”, and a determination can be made that the anti-haze mask has a recommendation value based on the hot news of “Chai Jing's speech ‘Under the Dome’”. Therefore, the anti-haze mask can be recommended to user.

Furthermore, in an event of determining to recommend the product to be recommended to the user, at least one of a brand of the product to be recommended (i.e., a product of which brand is recommended), a place of manufacture (a product of which origin is recommended), a price range (a product of which price range is recommended), seller information (a product of which seller is recommended), a picture, or text information used in the recommendation, can be determined.

In addition, in the field of e-commerce, an e-commerce platform providing procurement decisions to users (herein referred to as sellers) is also a relatively major service scenario. As popular news and information may affect prices and popularities of products, the method provided in the present embodiment may provide the sellers with a more accurate procurement decision. Specifically, respective categories to which various products belong are determined as target categories, and news information that match the respective target categories are obtained as target news information. A procurement strategy for a user is generated for the various products according to the target news information.

Generating the procurement strategy for the user for the various products according to the target news information includes, but is not limited to, the following processing.

For each product, a determination is made as to whether the product has a purchasing value for a user according to target news information, i.e., determining whether the user needs to purchase the product. For example, a category to which an anti-haze mask belongs matches the hot news related to “Chaff Jing's speech of ‘Under the Dome’”. A determination can be made that the sales of the anti-haze mask will increase substantially in the near future according to the hot news related to “Chaff Jing's speech of ‘Under the Dome’”. Therefore, the anti-haze mask has a purchasing value.

Furthermore, if a determination is made that the user needs to purchase this product, at least one of a number of items associated with a purchase, a price associated with the purchase, a time cycle of the purchase, or a merchant from which the purchase is made, etc., can also be determined.

As can be seen from above, the present embodiment first determines a target resource category to which a network resource to be processed belongs, obtains target news information that matches the target resource category, and performs service processing on the target resource network according to the target news information, thus providing a service processing method based on a matching relationship between the news information and the resource category, thus fully exerting the influence of the news information on a process of service processing, and improving an accuracy of the service processing, while enriching business processing methods at the same time.

In implementations, the matching relationship between the resource category and the news information may be pre-established. Based thereon, details of operation 102, i.e., obtaining the target news information matching the target resource category include querying the pre-established matching relationship between the resource category and the news information according to the target resource category to obtain the target resource category that matches the news information as the target news information.

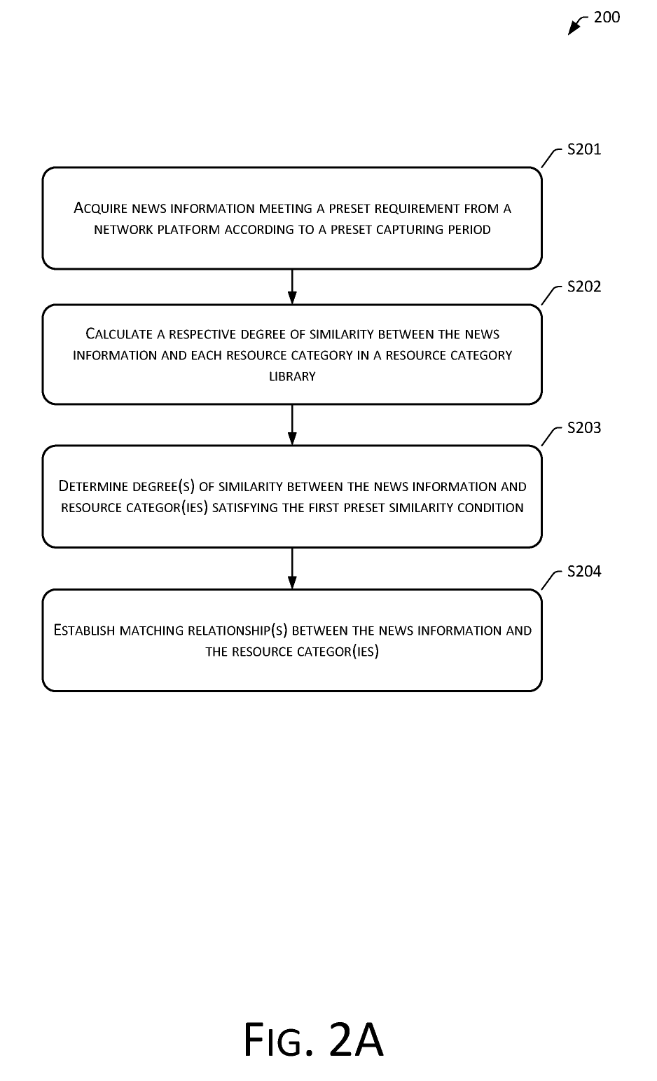

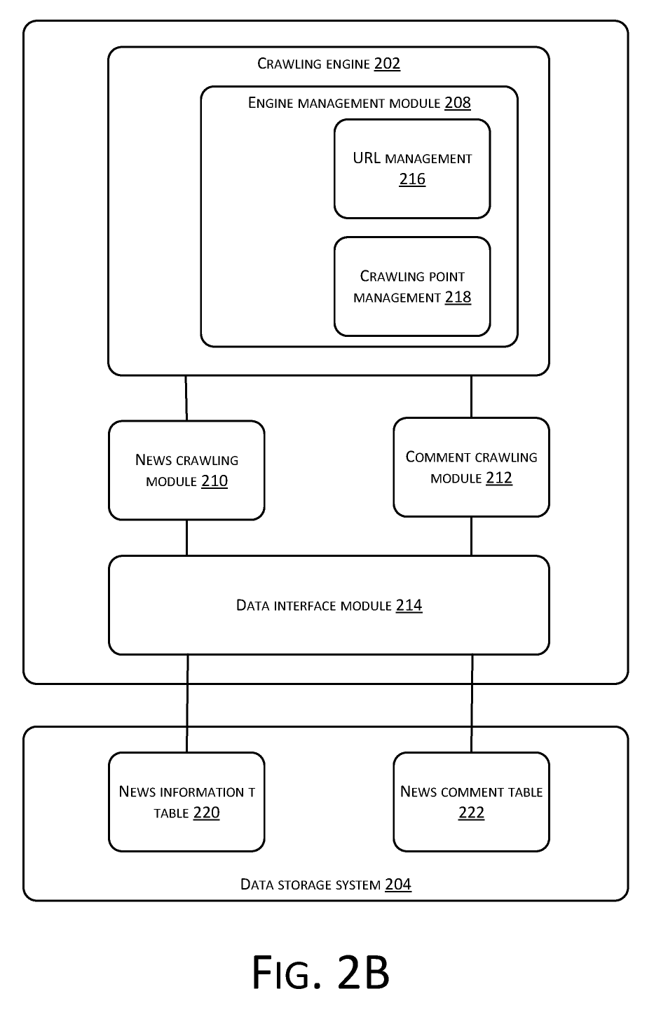

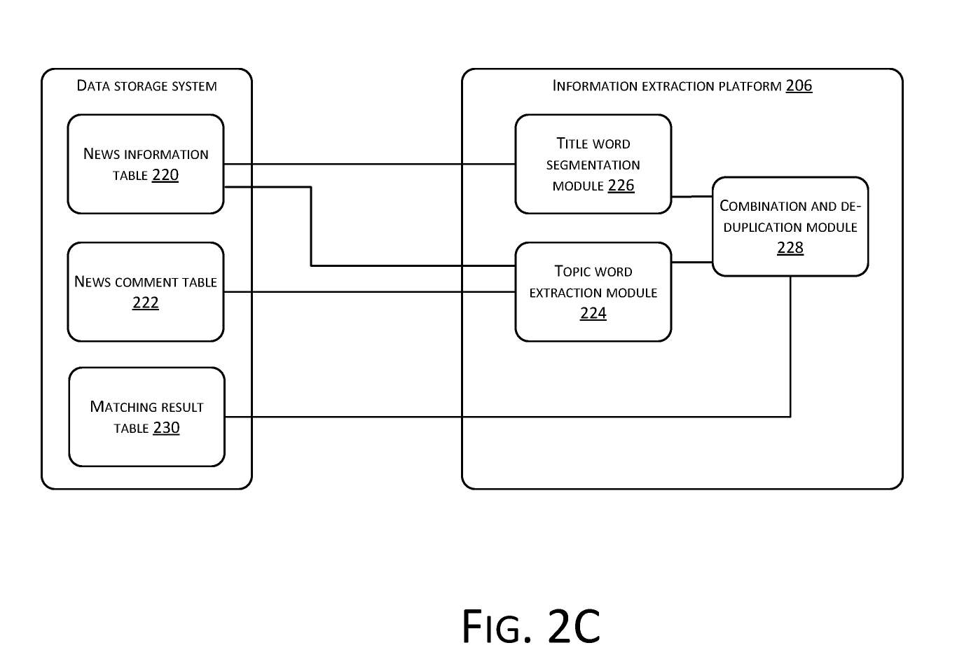

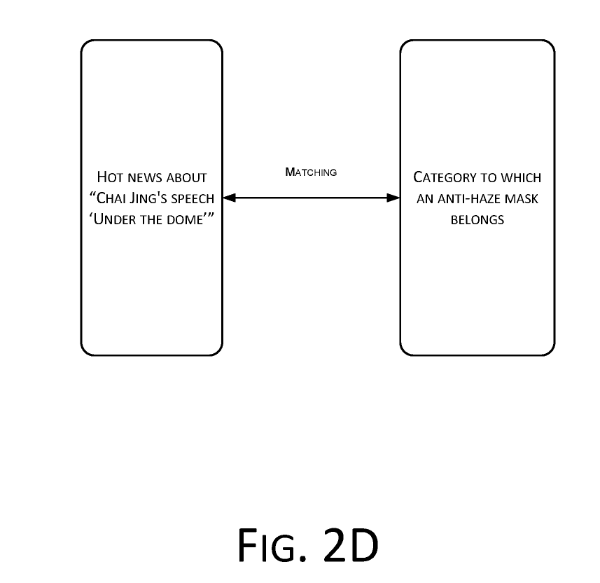

FIG. 2A is a flowchart of a data processing method 200 according to another embodiment of the present disclosure. The data processing method 200 is used for establishing matching relationships between resource categories and news information in advance. For example, in the foregoing implementations, matching relationships between resource categories and news information may be established in advance using the method shown in FIG. 2A, and a query may then be made to the matching relationships between the resource categories and the news information according to a target resource category to obtain target news information that matches the target resource category. It should be noted that the matching relationships between the resource categories and the news information that are established using the method shown in FIG. 2A can be applied to various application scenarios that require the matching relationships, and are not only applicable to the foregoing implementations. As shown in FIG. 2A, the method 200 includes the following operations.

S201: Acquire news information meeting a preset requirement from a network platform according to a preset capturing period.

S202: Calculate a respective degree of similarity between the news information and each resource category in a resource category library.

S203: Determine degree(s) of similarity between the news information and resource categor(ies) satisfying the first preset similarity condition.

S204: Establish matching relationship(s) between the news information and the resource categor(ies).

The method 200 as shown in FIG. 2A can be implemented using, but not limited to, system architectures of FIGS. 2B and 2C. Specifically, a crawling engine 202 as shown in FIG. 2B can capture news information meeting preset requirement(s) from a network platform according to a preset crawling period. The news information captured by the crawling engine 202 can be stored in a data storage system 204 as shown in FIG. 2B. The data storage system 204 can be implemented using a mysql relational database, but is not limited thereto. An information extraction platform 206 as shown in FIG. 2C extracts information and completes an establishment of matching relationship(s) between the news information and determined resource categor(ies) based on the extracted information.

The capturing period at operation 201 may be set adaptively according to an application scenario, and may be, for example, one day, one week, three days, five days, etc. In addition, taking into account of a large amount of pieces of news information on a network platform, and values of these pieces of news information will decrease as time goes by, requirement(s) is/are preset to specifically capture news information that meet the preset requirement(s) in the present embodiment. This can reduce the number of pieces of news information and improve the processing efficiency. The preset requirement(s) may be a degree of popularity being greater than a specified popularity threshold (so that hot news information can be obtained), or a time of occurrence being later than a specified time (so that recent news information may be obtained).

For example, the crawling engine 202 can use reptiles to capture hot news on major news websites (such as sina.com, with a website as www.sina.com.cn; sohu.com with a website as www.sohu.com, etc.). The so-called hot news is news information with a relatively high popularity, and may be, for example, news information positioned on the top of the news websites, such as the headline news. Preferably, the reptiles herein may employ, but not limited to, the Jsoup directional crawling technology.

For the captured news information, a respective degree of similarity between the news information and each resource category in a resource category library is calculated, and a resource category having a degree of similarity with the news information meets a first preset similarity condition is determined as a resource category matching the news information, and a matching relationship between the news information and the determined resource category is then established.

It is worth noting that multiple pieces of news information are generally captured during each capturing period. Each piece of news information is processed using the above method. In addition, as the number of capturing crawl periods increases, matching relationships between a large number of pieces of news information and respective resource categories can be established.

In implementations, the matching relationship between the news message and the resource category may be stored in the data storage system, but is not limited to a database.

Further, an implementation of operation S202 includes obtaining a keyword of the news information according to at least one type of information in a body, a title, and comment information of the news information; performing word segmentation on each resource category to obtain respective keyword(s) for each resource category; and calculating the respective degree of similarity between the news information and each resource category based on the keyword of the news information and the respective keyword(s) of each resource category.

Further, the crawling engine 202 can be subdivided into an engine management module 208, a news crawling module 210, a comment crawling module 212, and a data interface module 214. The engine management module 208 is responsible for managing a URL on a network (marked as URL management 216), and managing a URL that needs to be crawled (referred to as crawling point management 218).

News information is used to describe a fact, and the body and the title of the news information can express the main meaning of the news information. Specifically, the news crawling module 210 can capture news information and store the captured news information in a news information table 220 in the data storage system 204 through the data interface module 214. The comment information of the news information can reflect points of concern of network users (which may be abbreviated as netizens). For example, in the news information about “who's wrong in the incident that Chengdu female driver was beaten?”, the full text does not mention any driving recorder. This news information alone cannot be used to retrieve such information about a driving recorder. However, in netizens' comments following thereafter, many people mentioned the importance of driving recorders. Specifically, the comment crawling module 212 can capture the comment information of the news information, and store the captured comment information into a news comment table 222 in the data storage system 204 through the data interface module 214.

Based on the foregoing description, the information extraction platform 206 may specifically obtain at least one type of information in the body, the title and the comment information of the news information from the data storage system, perform keyword extraction on the at least one type of information in the body, the title and the comment information of the news information to obtain at least one of body keywords, title keywords, and comment keywords, and combine and de-duplicate the at least one of the body keywords, the title keywords, and the comment keywords to obtain a keyword of the news information.

Furthermore, the information extraction platform 206 as shown in FIG. 2A can be subdivided into a topic word extraction module 224, a title word segmentation module 226, and a combination and de-duplication module 228.

Alternatively, because of its large amount of information, a process of keyword extraction for the body of the news information may include the topic word extraction module 224 to perform a topic word extraction thereon. Due to its relative simplicity, a method of keyword segmentation for the title of the news information may include the title word segmentation module 226 to perform word segmentation thereon. Because of its large amount of information, a method of keyword extraction for the comment information of the news message may include the topic word extraction module 224 to perform topic word extraction thereon.

The reason why de-duplication is performed due to consideration of possible duplications of hot news captured from major news websites. For example, the Tianjin bombing incident was the headlines of major news websites for a time, and so the same news information is very likely captured from different news websites. Therefore, keywords with high repetition or similarity may appear, and therefore duplicated or highly similar keywords (for example, greater than a certain threshold) need to be combined into one.

In implementations, the de-duplication herein may be specifically implemented using a clustering algorithm. Specifically, clustering is performed on at least one of the body keywords, the title keywords, and the comment keywords. Keywords that are clustered into one class are replaced with one of the keywords. For example, these keywords can be described using a vector space model and clustered using an agglomerative hierarchical clustering algorithm to classify similar keywords in the same class. For example, for the news information related to the Tianjin bombing incident, keywords that can be extracted include “explosion”, “fire”, “firefighter”, “Binhai New Area”, “dangerous material”, “environmental pollution”, “death and injuries”, etc. The keywords “fire”, “explosion”, and “firefighter” are all highly similar to a subcategory that is related to a “fire extinguisher”. Therefore, these keywords need to be grouped together into one cluster, and a keyword is selected therefrom to represent all the keywords all the keywords in this cluster.

Preferably, keywords of news information may be obtained by using the body, the title, and the comment information of the news information at the same time. In this case, a specific implementation of obtaining the keywords of the news information by using the text, the title, and the comment information of the news information at the same time includes extraction processing, filtering processing, and combination and de-duplication processing.

Extraction processing refers to separately extracting topic words from the body and comment information of news information to obtain body keywords and comment keywords, and performing word segmentation on the title of the news information to obtain title keywords.

Alternatively, in order to facilitate separate processing of these three types of information, these three types of information may be stored using two tables. For example, the body and title of the news information may be stored in the news information table 220 as shown in FIG. 2B. The comment information of the news information is stored in the news comment table 222 as shown in FIG. 2B to facilitate separate processing.

In a process of extracting topic words of the comment information of the news information, a TF-IDF model may be used to extract foci of attention of netizens as the comment keywords. For example, in the news information about that a Chengdu female driver being beaten, a large number of driving recorders appear in the comments of netizens. Through the TF-IDF model, a comment keyword associated with this driving recorder could be quickly mined.

The filtering processing refers to filtering the text keywords, the title keywords, and the comment keywords to remove terms such as stop words, names of people, names of places, and time, etc. For example, word segmentation is performed on the news title of “Engineering Academicians: Contaminants in Beijing-Tianjin-Hebei Region Remarkably Rise after ‘Parade in Blue Sky’” to obtain title keywords including terms such as “Engineering Academician”, “parade”, “blue”, “after”, “Beijing-Tianjin-Hebei Region”, “contaminants,” “remarkably,” and “rise”, etc. The “after” is a stop word, and is removed.

Combination and de-duplication processing refers to merging and de-duplicating the filtered text keywords, title keywords, and comment keywords to obtain a keyword of the news information.

After obtaining the keyword of the news information, a respective degree of similarity between the news information and each resource category may be calculated according to the keyword of the news information and a keyword of each resource category. An implementation of calculating the respective degree of similarity between the news information and each resource category according to the keyword of the news information and the keyword of each resource category includes obtaining a word vector of the keyword of the news information and a word vector of the keyword of each resource category; and calculating the respective degree of similarity between the news information and each resource category based on the word vector of the keyword of the news information and the word vector of the keyword of each resource category.

For example, in a real application, a Word2Vec model may be used to calculate degrees of similarity between news information and resource categories. The Word2Vec model needs to use a corpus. In the present embodiment, the corpus can be made up of a large number of news information related to network resources, network resources and associated details provided by network resource providers, comment information of news information, resource category information, and the like.

Alternatively, considering that more than one keyword may exist in news information, and more than one keyword may exist in each resource category, the number of keywords in news information is denoted as n, and the number of keywords in a resource category is denoted as m, where n and m are natural numbers greater than one. Accordingly, an implementation of calculating the degree of similarity between the news information and each resource category based on the word vector of the keyword of the news information and the word vector of the keyword of each resource category includes: calculating, for each keyword of n keywords, a degree of similarity between a word vector of the keyword and a word vector of each keyword of m keywords to obtain n*m degrees of similarity; and obtaining an average of the n*m degrees of similarity, and using the average of the n*m degrees of similarity as the degree of similarity between the news information corresponding to the n keywords and a resource category corresponding to the m keywords.

According to the foregoing method, a degree of similarity between news information and each resource category can be calculated, and a resource category satisfying a first preset similarity condition can then be selected as a resource category that matches the news information. Electronic commerce is used as an example. A matching relationship between news information and resource categories is shown in FIG. 2D. In FIG. 2D, the left side is the hot news of “Chaff Jing's speech ‘under the dome’”, and the right side is a category to which anti-haze masks that match the news information.

In implementations, details of operation S102, i.e., obtaining the target news information that matches the target resource category specifically include calculating a degree of similarity between each piece of news information in a news corpus and the target resource category; and obtaining a piece of news information having a degree of similarity with the target resource category satisfying a second preset similarity condition to serve as the target news information.

An implementation of calculating the degree of similarity between each piece of news information in the news corpus and the target resource category includes performing word segmentation on the target resource category to obtain a keyword of the target resource category; and for each piece of news information, obtaining a keyword of the respective piece of news information based on at least one type of information in a body, a title, and comment information of the respective piece of news information, and calculating a degree of similarity between the respective piece of news information and the target resource category based on the keyword of the respective piece of news information and the keyword of the target resource category.

It should be noted that the present implementation is similar to the implementation of operation 202. Details of the implementation of each operation can be referenced to corresponding description in the specific implementation of operation 202, and are not repeatedly described herein.

Correspondingly, calculating the degree of similarity between the respective piece of news information and the target resource category based on the keyword of the respective piece of news information and the keyword of the target resource category includes obtaining a word vector of the keyword of the respective piece of news information and a vector of the keyword of the target resource category; and calculating the degree of similarity between the respective piece of news information and the target resource category based on the word vector of the keyword of the respective piece of news information and the word vector of the keyword of the target resource category.

For example, in a real application, a Word2Vec model may be used to calculate a degree of similarity between a piece of news information and a target resource category.

Alternatively, considering that more than one keyword may exist in a piece of news information, and more than one keyword may exist in a target resource category, the number of keywords of the news information is denoted as l, and the number of keywords of the target resource category is denoted by k, where l and k are natural numbers greater than one. Accordingly, an implementation of calculating the degree of similarity between the respective piece of news information and the target resource category based on the word vector of the keyword of the respective piece of news information and the word vector of the keyword of the target resource category includes: for each keyword of the I keywords, separately calculating similarity between a word vector of the respective keyword and a word vector of each keyword of the k keywords to obtain l*k degrees of similarity; and obtaining an average of the l*k degrees of similarity, and using the average of the l*k degrees of similarity as the degree of similarity between the piece of news information corresponding to the l keywords and the target resource category corresponding to the k keywords.

According to the above method, a degree of similarity between each piece of news information in a news corpus and a target resource category can be calculated, and a piece of news information satisfying a second preset similarity condition can be selected as the news information that matches the target resource category.

Furthermore, after obtaining the matching relationship between the news information and the resource category, the matching relationship may alternatively be stored in the data storage system shown 204 in FIG. 2C, and may specifically be stored in a matching result table 230 in the data storage system 204 shown in FIG. 2C.

The above method embodiments find matching news information from the perspective of network resources, and then perform service processing on the network resources based on the matching news information. The following method embodiments will find a resource category that matches news information from the perspective of the news information, and then perform service processing on network resources under the resource category that matches the news information.

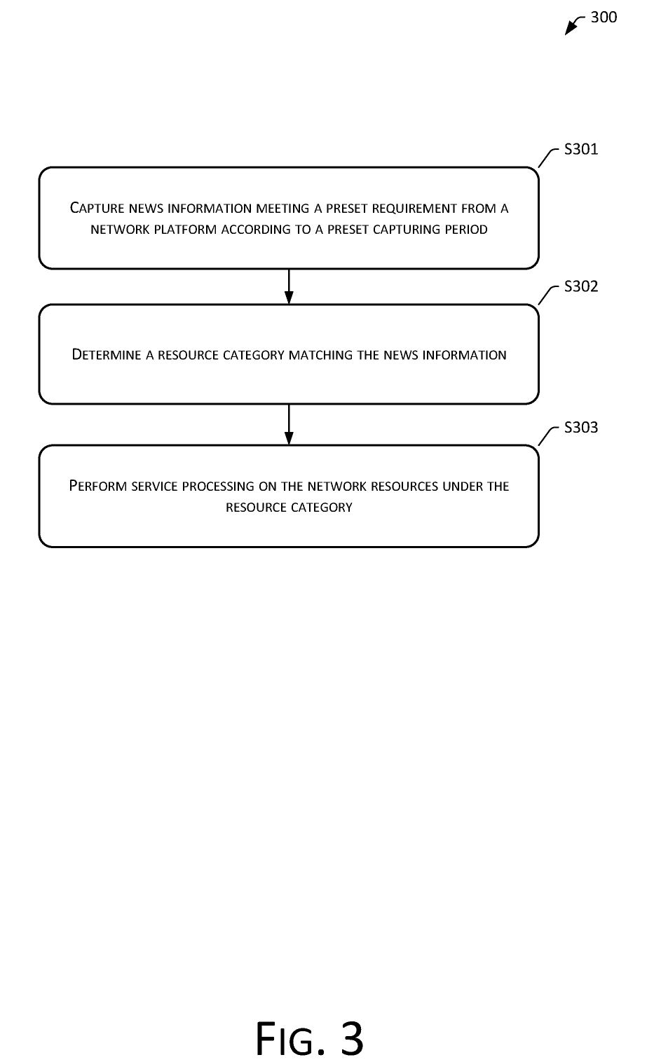

FIG. 3 is a flowchart of a service processing method 300 in accordance with another embodiment of the present disclosure. As shown in FIG. 3, the method 300 includes the following operations.

S301: Capture news information meeting a preset requirement from a network platform according to a preset capturing period.

S302: Determine a resource category matching the news information.

S303: Perform service processing on the network resources under the resource category.

The present embodiment provides a service processing method that can be executed by a service processing apparatus to implement a new process of service processing, thus improving the quality of service processing, and enriching service processing methods.

After analysis and research of the inventors of the present disclosure, news information is found to be closely related to network resources and services that rely on the network resources. A most direct discovery of the inventors of the present disclosure is that the sales of some commodities are often affected by hot news and information in the field of e-commerce. For example, the recent hot news related to the Tianjin bombings triggered people to pay attention to fire safety and environmental pollution, thereby boosting the sales volumes of such products as fire extinguishers, masks, and disinfecting water, etc. The hot news about “Chai Jing's speech under the dome” triggered people to pay attention to air quality around them, and thereby led to an increase in the sales of anti-haze masks and other commodities. The hot news of “Chengdu female driver was beaten” that mentioned a driving recorder caused everyone to pay attention to driving recorders, and products related to driving recorders also hit a sales peak.

Based on the above considerations, the inventors of the present disclosure provide a new service processing method. A main principle thereof is to perform service processing based on a matching relationship between a resource category and news information. For the sake of description, a resource category matching new information in the service processing method of the present disclosure is called a target resource category.

First, the embodiments of the present disclosure do not have any limitations on the content of news information, which may include, for example, at least one of a news event, a hot topic, a character trend, product information, or the like. In addition, an implementation format of news information is also not limited, which may include, for example, at least one of a text, a picture, a video, or the like.

In addition, a resource category in the embodiments of the present disclosure refers to a category to which a network resource belongs. The embodiments of the present disclosure do not have any limitations on a type of a network resource. In different application scenarios, network resources will be different, and categories of the network resources will also be different. For example:

In the field of e-commerce, network resources can be various types of commodities and services provided by sellers. Correspondingly, resource categories can be categories to which the network resources belong, such as women's wear, men's wear, shoes, life, learning, sports, outdoor, and maternal and child care, etc. It should be noted that the embodiments of the present disclosure do not have any limitations on category levels. In other words, in the embodiments of the present disclosure, resource categories may include categories of various levels.

Based on the above introduction, a service processing method of the present embodiment specifically includes:

First, news information meeting a preset requirement is obtained from a network platform according to a preset capturing period.

The capturing period at the above operation may be set adaptively according to an application scenario, and may be, for example, one day, one week, three days, five days, etc. In addition, taking into account of a large amount of pieces of news information on a network platform, and values of these pieces of news information will decrease as time goes by, requirement(s) is/are preset to specifically capture news information that meet the preset requirement(s) in the present embodiment. This can reduce the number of pieces of news information and improve the processing efficiency. The preset requirement(s) may be a degree of popularity being greater than a specified popularity threshold (so that hot news information can be obtained), or a time of occurrence being later than a specified time (so that recent news information may be obtained).

For example, reptiles can be used to capture hot news on major news websites (such as sina.com, with a website as www.sina.com.cn; sohu.com with a website as www.sohu.com, etc.). The so-called hot news is news information with a relatively high popularity, and may be, for example, news information positioned on the top of the news websites, such as the headline news. Preferably, the reptiles herein may employ, but not limited to, the Jsoup directional crawling technology.

Moreover, the captured news information can be stored in a data storage system. The data storage system can be implemented using a mysql relational database, but is not limited thereto.

After the news information is captured, a target resource category matching the captured news information can be determined.

In implementations, determining the target resource category includes calculating a respective degree of similarity between the news information and each resource category; and determining a resource category having a degree of similarity with the news information satisfying a first preset similarity condition as the target resource category.

Furthermore, determining the target resource category includes calculating the respective degree of similarity between the news information and each resource category includes obtaining a keyword of the news information according to at least one type of information in a body, a title, and comment information of the news information; performing word segmentation on each resource category to obtain a keyword for each resource category; and calculating the respective degree of similarity between the news information and each resource category based on the keyword of the news information and the keyword of each resource category.

Furthermore, obtaining the keyword of the news information according to the at least one type of information in the body, the title, and the comment information of the news information includes performing keyword extraction on the at least one type of information in the body, the title and the comment information of the news information to obtain at least one of body keywords, title keywords, and comment keywords; and combining and de-duplicating the at least one of the body keywords, the title keywords, and the comment keywords to obtain the keyword of the news information.

Furthermore, In implementations, calculating the respective degree of similarity between the news information and each resource category based on the keyword of the news information and the keyword of each resource category includes obtaining a word vector of the keyword of the news information and a word vector of the keyword of each resource category; and calculating the respective degree of similarity between the news information and each resource category based on the word vector of the keyword of the news information and the word vector of the keyword of each resource category.

It is noted herein that details of implementations of each of the above operations can be referenced to descriptions of corresponding operations in the embodiment shown in FIG. 2A, and are not repeatedly described herein.

After the target resource category matching the captured news information is determined, service processing is performed on network resources under the target resource category.

It is worth noting that specific processes of service processing for network resources under a target resource category will be different according to different application scenarios. Some service scenarios in the field of electronic commerce are used as examples for illustration. Based on the following examples, one skilled in the art can implement processes of service processing for network resources under a target resource category in other application scenarios.

In the field of e-commerce, an e-commerce platform recommending products to users is a relatively common service scenario. As popular news and information may affect prices and popularities of the products, the method provided in the present embodiment may be used to recommend products to a user. Specifically, news information meeting a preset requirement is captured from a network platform according to a preset capturing period. A target resource category matching the news information is determined. Recommendation processing is performed for products under the target resource category.

Performing recommendation processing on the products under the target resource category includes, but is not limited to, the following processing:

determining whether a product under the target resource category has a recommendation value, and determining a recommendation strength and a way of recommendation needed during recommendation after determining that the product has the recommendation value, etc.

As can be seen from above, the present embodiment captures news information, determines a target resource category that matches the news information, and performs service processing based on the target resource category to provide a service processing method based on matching relationships between news information and resource categories, thus fully exerting an impact of news information on a process of service processing, improving an accuracy of service processing, while enriching service processing methods.

It is noted herein that the methods provided by the above embodiments of the present disclosure can be applied to the field of e-commerce. In this case, the network resources can be commodities on an e-commerce platform, and the categories to which the network resources belong can be commodity categories. Matching relationships between hot news and commodity categories can be established to help buyers and sellers to grasp industry's hotspot information so that the buyers and the sellers can conduct business processing or decisions based on the matching relationships. In addition, the technical solutions of the present disclosure require no manual intervention when implemented, and can automatically capture hot news, thus achieving intelligentization, automation, and relatively high efficiency.

It should be noted that the foregoing method embodiments are all expressed as series of action combinations for the sake of description. However, one skilled in the art should know that the present disclosure is not limited to the described orders of actions because certain operations may be performed in other orders or simultaneously according to the present disclosure. Moreover, one skilled in the art should also understand that the embodiments described in the specification all belong to exemplary embodiments, and actions and modules involved therein may not be necessarily required by the present disclosure.

In the above embodiments, descriptions of various embodiments have different emphases. Portions of a certain embodiment that are not described in detail can be referenced to related description of other embodiments.

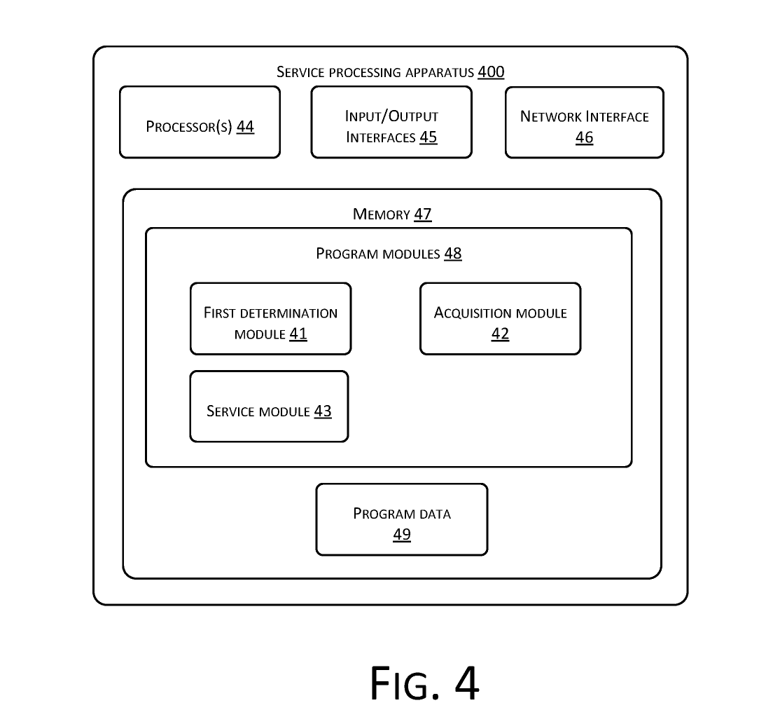

FIG. 4 is a schematic structural diagram of a service processing apparatus 400 in accordance with another embodiment of the present disclosure. In implementations, the apparatus 400 may include one or more computing devices. In implementations, the apparatus 400 may be a part of one or more computing devices, e.g., implemented or run by the one or more computing devices. In implementations, the one or more computing devices may be located in a single place or distributed among a plurality of network devices over a network. By way of example and not limitation, as shown in FIG. 4, the apparatus 400 may include a first determination module 41, an acquisition module 42, and a service module 43.

The first determination module 41 is configured to determine a target resource category to which a network resource to be processed belongs.

The acquisition module 42 is configured to obtain target news information that matches the target resource category determined by the first determination module 41.

The service module 43 is configured to perform service processing on the network resource to be processed according to the target news information obtained by the acquisition module 42.

In implementations, the acquisition module 42 may specifically configured to query pre-established matching relationships between resource categories and news information based on the target resource category to obtain the target news information.

In implementations, the service processing apparatus 400 may also include one or more processors 44, an input/output (I/O) interface 45, a network interface 46, and memory 47.

The memory 47 may include a form of computer readable media such as a volatile memory, a random access memory (RAM) and/or a non-volatile memory, for example, a read-only memory (ROM) or a flash RAM. The memory 47 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 47 may include program modules 48 and program data 49.

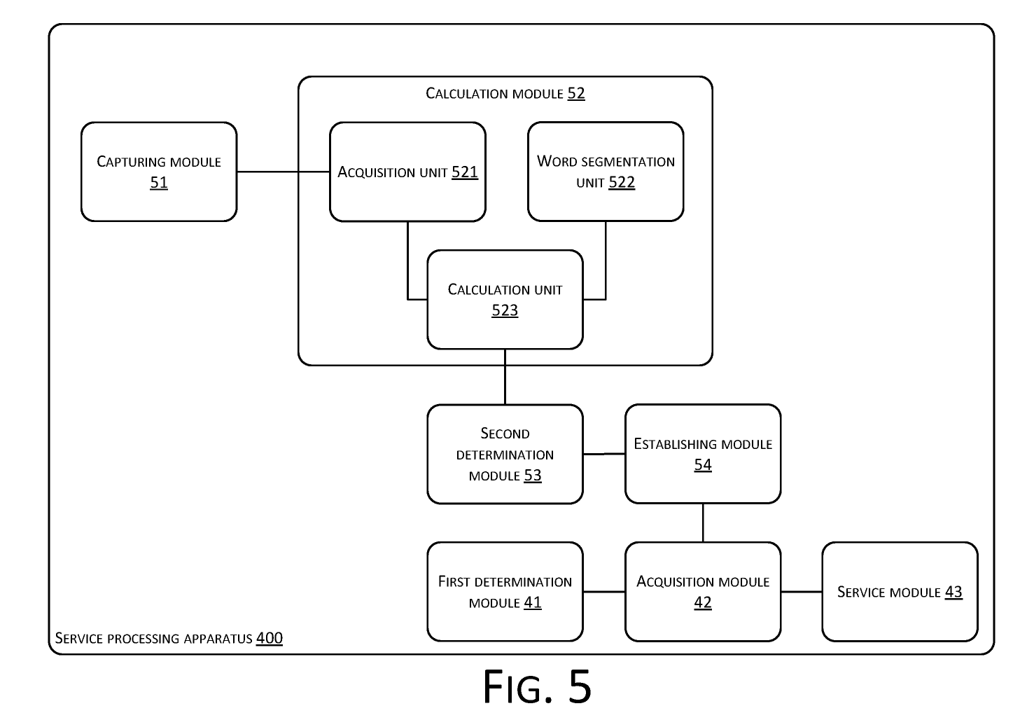

In implementations, as shown in FIG. 5, the apparatus 400 further includes a capturing module 51, a calculation module 52, a second determination module 53, and an establishing module 54.

The capturing module 51 is configured to capture news information meeting a preset requirement from a network platform according to a preset capturing period.

The calculation module 52 is configured to calculate a respective degree of similarity between the news information and each resource category in a resource category library.

The second determination module 53 is configured to determine a resource category having a degree of similarity with the news information that meets a first preset similarity condition.

The establishing module 54 is configured to establish a matching relationship between the news information and the resource category determined by the second determination module 53.

Furthermore, as shown in FIG. 5, an implemented structure of the calculation module 52 includes an acquisition unit 521, a word segmentation unit 522, and a calculation unit 523.

The acquisition unit 521 is configured to obtain a keyword of the news information according to at least one type of information in a body, a title, and comment information of the news information.

The word segmentation unit 522 is configured to perform word segmentation on each resource category to obtain a respective keyword for each resource category.

The calculation unit 523 is configured to calculate the respective degree of similarity between the news information and each resource category based on the keyword of the news information obtained by the acquisition unit 521 and the respective keyword of each resource category obtained by the word segmentation unit 522.

Furthermore, the acquisition unit 521 is specifically configured to perform keyword extraction on the at least one type of information in the body, the title and the comment information of the news information to obtain at least one of body keywords, title keywords, and comment keywords, and combine and de-duplicate the at least one of the body keywords, the title keywords, and the comment keywords to obtain the keyword of the news information.

Furthermore, the calculation unit 523 is specifically configured to obtain a word vector of the keyword of the news information and a word vector of the keyword of each resource category; and calculate the respective degree of similarity between the news information and each resource category based on the word vector of the keyword of the news information and the word vector of the keyword of each resource category.

In implementations, the acquisition module 42 is specifically configured to calculate a degree of similarity between each piece of news information in a news corpus and the target resource category, and obtain a piece of news information having a degree of similarity with the target resource category satisfying a second preset similarity condition to serve as the target news information.

Furthermore, when calculating the degree of similarity between each piece of news information in the news corpus and the target resource category, the acquisition module 42 is specifically configured to:

perform word segmentation on the target resource category to obtain a keyword of the target resource category; and

for each piece of news information, obtain a keyword of the respective piece of news information based on at least one type of information in a body, a title, and comment information of the respective piece of news information, and calculate a degree of similarity between the respective piece of news information and the target resource category based on the keyword of the respective piece of news information and the keyword of the target resource category.

Furthermore, when calculating the degree of similarity between the respective piece of news information and the target resource category based on the keyword of the respective piece of news information and the keyword of the target resource category, the acquisition module 42 is specifically configured to:

obtain a word vector of the keyword of the respective piece of news information and a vector of the keyword of the target resource category; and

calculate the degree of similarity between the respective piece of news information and the target resource category based on the word vector of the keyword of the respective piece of news information and the word vector of the keyword of the target resource category.

In implementations, the network resource to be processed may be a commodity, the target resource category may be a category to which the commodity belongs. Correspondingly, the matching relationships between the news information and the resource categories are matching relationships between news information and commodities.

The service module provided by the present embodiment determines a target resource category to which a network resource to be processed belongs, obtains target news information matching the target resource category, and performs service processing on the network resource to be processed based on the target news information, thus implementing service processing based on a matching relationship between the news information and the resource category, fully exerting an impact of the news information on a process of the service processing. This improves an accuracy of the service processing while enriching the ways of the service processing.

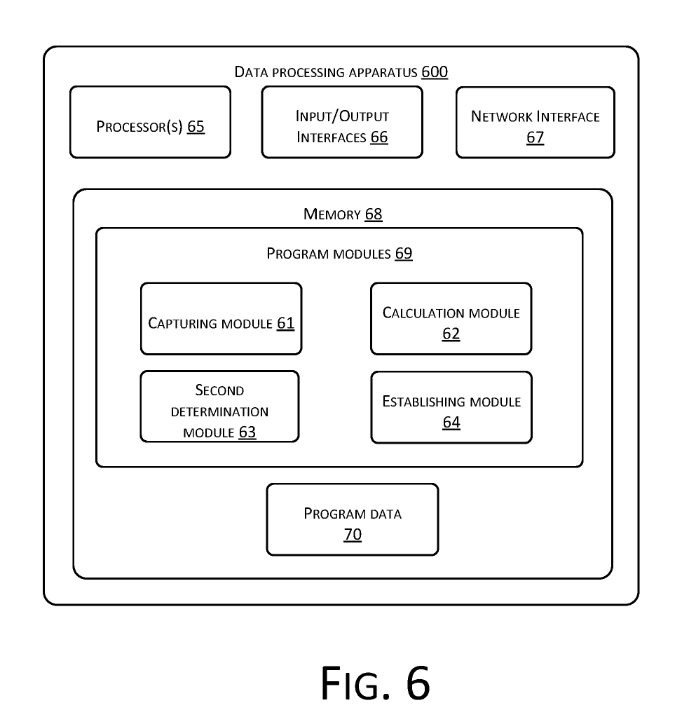

FIG. 6 is a schematic structural diagram of a data processing apparatus 600 in accordance with another embodiment of the present disclosure. In implementations, the apparatus 600 may include one or more computing devices. In implementations, the apparatus 600 may be a part of one or more computing devices, e.g., implemented or run by the one or more computing devices. In implementations, the one or more computing devices may be located in a single place or distributed among a plurality of network devices over a network. By way of example and not limitation, as shown in FIG. 6, the apparatus 600 may include a capturing module 61, a calculation module 62, a determination module 63, and an establishing module 64.

The capturing module 61 is configured to capture news information meeting a preset requirement from a network platform according to a preset capturing period.

The calculation module 62 is configured to calculate a respective degree of similarity between the news information and each resource category in a resource category library.

The determination module 63 is configured to determine a resource category having a degree of similarity with the news information that meets a first preset similarity condition.

The establishing module 64 is configured to establish a matching relationship between the news information and the resource category determined by the determination module 63.

In implementations, the data processing apparatus 600 may also include one or more processors 65, an input/output (I/O) interface 66, a network interface 67, and memory 68.

The memory 68 may include a form of computer readable media as described in the foregoing description. In implementations, the memory 68 may include program modules 69 and program data 70.

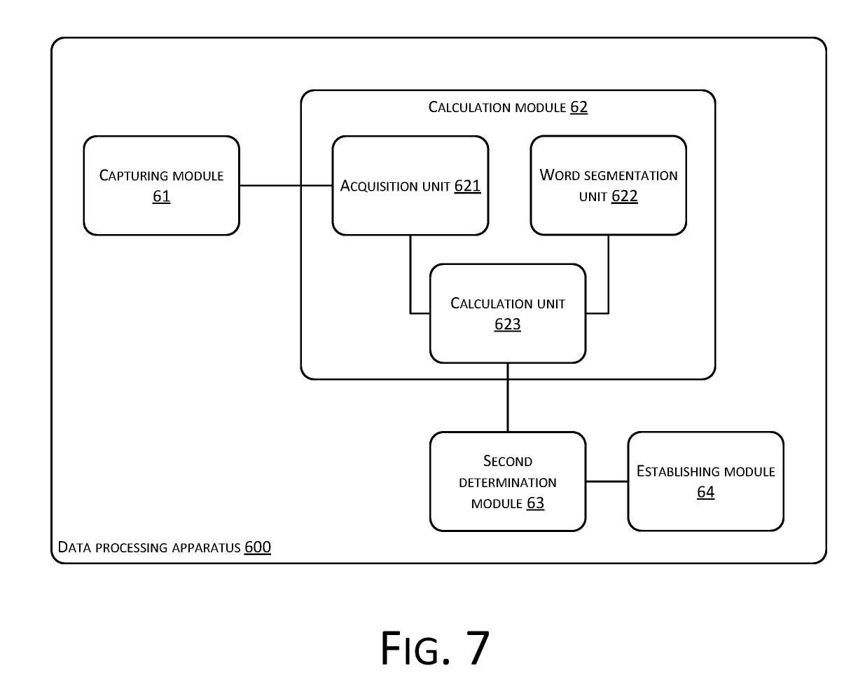

In implementations, as shown in FIG. 7, an implemented structure of the calculation module 62 includes an acquisition unit 621, a word segmentation unit 622, and a calculation unit 623.

The acquisition unit 621 is configured to obtain a keyword of the news information according to at least one type of information in a body, a title, and comment information of the news information.

The word segmentation unit 622 is configured to perform word segmentation on each resource category to obtain a respective keyword for each resource category.

The calculation unit 623 is configured to calculate the respective degree of similarity between the news information and each resource category based on the keyword of the news information and the respective keyword of each resource category.

Furthermore, the acquisition unit 621 is specifically configured to perform keyword extraction on the at least one type of information in the body, the title and the comment information of the news information to obtain at least one of body keywords, title keywords, and comment keywords, and combine and de-duplicate the at least one of the body keywords, the title keywords, and the comment keywords to obtain the keyword of the news information.

Furthermore, the calculation unit 623 is specifically configured to obtain a word vector of the keyword of the news information and a word vector of the keyword of each resource category; and calculate the respective degree of similarity between the news information and each resource category based on the word vector of the keyword of the news information and the word vector of the keyword of each resource category.

In implementations, a resource category here may be a category to which a product belongs. Correspondingly, a matching relationship between the news information and the resource category is specifically a matching relationship between the news information and a product category.

The data processing apparatus provided by the present embodiment captures news information, calculates a degree of similarity between the news information and each resource category, determines a resource category matching the news information based on the degree of similarity, and establishes a matching relationship between the news information and the determined resource category, thus providing conditions for subsequent service processing based on network resources.

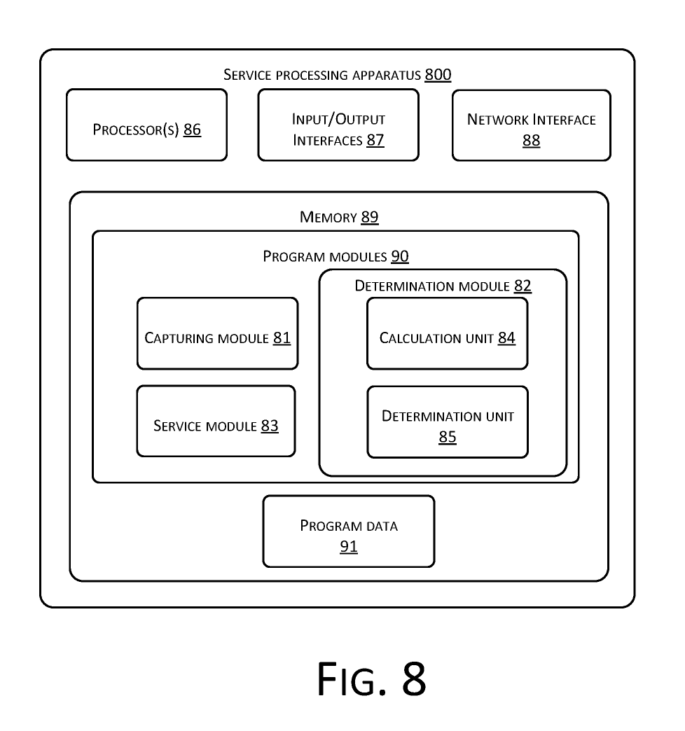

FIG. 8 is a schematic structural diagram of a service processing apparatus 800 in accordance with another embodiment of the present disclosure. In implementations, the apparatus 800 may include one or more computing devices. In implementations, the apparatus 800 may be a part of one or more computing devices, e.g., implemented or run by the one or more computing devices. In implementations, the one or more computing devices may be located in a single place or distributed among a plurality of network devices over a network. By way of example and not limitation, as shown in FIG. 8, the apparatus includes a capturing module 81, a determination module 82, and a service module 83.

The capturing module 81 is configured to capture news information meeting a preset requirement from a network platform according to a preset capturing period.

The determination module 82 is configured to determine a target resource category that matches the news information.

The service module 83 is configured to perform service processing on a network resource under the target resource category.

In implementations, an implemented structure of the determination module 82 includes a calculation unit 84 and a determination unit 85.

The calculation unit 84 is configured to calculate a respective degree of similarity between the news information and each resource category in a resource category library.

The determination unit 85 is configured to determine a resource category having a degree of similarity with the news information that meets a first preset similarity condition as the target resource category.

Furthermore, the calculation unit 84 is specifically configured to:

obtain a keyword of the news information according to at least one type of information in a body, a title, and comment information of the news information;

perform word segmentation on each resource category to obtain a respective keyword for each resource category; and

calculate the respective degree of similarity between the news information and each resource category based on the keyword of the news information and the respective keyword of each resource category.

Furthermore, when obtaining the keyword of the news information according to the at least one type of information in the body, the title, and the comment information of the news information, the calculation unit 84 is specifically configured to perform keyword extraction on the at least one type of information in the body, the title and the comment information of the news information to obtain at least one of body keywords, title keywords, and comment keywords, and combine and de-duplicate the at least one of the body keywords, the title keywords, and the comment keywords to obtain the keyword of the news information.

Furthermore, when calculating the respective degree of similarity between the news information and each resource category based on the keyword of the news information and the respective keyword of each resource category, the calculation unit 84 is specifically configured to obtain a word vector of the keyword of the news information and a word vector of the keyword of each resource category; and calculate the respective degree of similarity between the news information and each resource category based on the word vector of the keyword of the news information and the word vector of the keyword of each resource category.

In implementations, the data processing apparatus 800 may also include one or more processors 86, an input/output (I/O) interface 87, a network interface 88, and memory 89.

The memory 89 may include a form of computer readable media as described in the foregoing description. In implementations, the memory 89 may include program modules 90 and program data 91.

The service processing apparatus provided by the present embodiment captures news information, determines a target resource category matching the news information, and thereby performs service processing on network resources under the target resource category, thus providing a service processing method based on a matching relationship between the news information and the resource category, which fully exerts an impact of the news information on a process of service processing, and improves an accuracy of service processing, while enriching the service processing method.

One skilled in the art can clearly understand that, for the convenience and ease of description, specific work processes of the above described systems, apparatuses and units can be referenced to corresponding processes in the foregoing method embodiments and are not repeatedly described herein.

In the embodiments provided in the present disclosure, it should be understood that the disclosed systems, apparatuses, and methods may be implemented in other ways. For example, the apparatus embodiments described above are merely illustrative. For example, the division of the units is only one type of division of logical functions. In practice, other ways of division exist. For example, multiple units or components may be combined or may be integrated into another system, or some features can be ignored or not performed. In addition, a mutual coupling, a direct coupling or a communication connection, that is shown or discussed, may be an indirect coupling or a communication connection through some interfaces, apparatuses or units, and may be in an electrical, mechanical or other form.

The units described as separate components may or may not be physically separated, and the components displayed as units may or may not be physical units, that is, may be located in one place, or may be distributed among multiple network units. Some or all of the units may be selected according to actual needs to achieve the purpose of the present solutions of the embodiments.

In addition, various functional units in each embodiment of the present disclosure may be integrated in a single processing unit, or each unit may exist alone physically, or two or more units may be integrated in a single unit. The above-mentioned integrated unit can be implemented either in a form of hardware or in a form of hardware plus software functional unit(s).

The above-described integrated unit implemented as a software functional unit may be stored in a computer readable storage media. The software functional unit is stored in a storage media and includes instructions to cause a computing device (which may be a personal computer, a server, or a network device, etc.) or a processor to perform some operations of the method described in each embodiment of the present disclosure. The storage media includes various media capable of storing program codes such as a flash drive, a removable hard disk, Read-Only Memory (ROM), Random Access Memory (RAM), a magnetic disk, or an optical disk.

Finally, it should be noted that the above embodiments are only used to illustrate the technical solutions of the present disclosure, rather than limiting the present disclosure. Although the present disclosure has been described in detail with reference to the foregoing embodiments, one of ordinary skill in the art should understand that the technical solutions described in the foregoing embodiments can be modified, or some of the technical features can be equivalently replaced. These modifications or replacements do not make the nature of the corresponding technical solutions to depart from the spirit and scope of the technical solutions of the embodiments of the present disclosure.

The present disclosure can be further understood using the following clauses.

Clause 1: A service processing method comprising: determining a target resource category to which a network resource to be processed belongs; obtaining target news information that matches the target resource category; and performing service processing on the network resource to be processed according to the target news information.

Clause 2: The method of Clause 1, wherein obtaining the target news information that matches the target resource category comprises querying pre-established matching relationships between resource categories and news information based on the target resource category to obtain the target news information.

Clause 3: The method of Clause 2, wherein establishing the matching relationships between resource categories and news information comprises: capturing news information meeting a preset requirement from a network platform according to a preset capturing period; calculating a respective degree of similarity between the news information and each resource category in a resource category library; determining a resource category having a degree of similarity with the news information that meets a first preset similarity condition; and establishing a matching relationship between the news information and the resource category.

Clause 4: The method of Clause 3, wherein calculating the respective degree of similarity between the news information and each resource category in the resource category library comprises: obtaining a keyword of the news information according to at least one type of information in a body, a title, and comment information of the news information; performing word segmentation on each resource category to obtain a respective keyword for each resource category; and calculating the respective degree of similarity between the news information and each resource category based on the keyword of the news information and the respective keyword of each resource category.

Clause 5: The method of Clause 4, wherein obtaining the keyword of the news information according to the at least one type of information in the body, the title, and the comment information of the news information comprises: performing keyword extraction on the at least one type of information in the body, the title and the comment information of the news information to obtain at least one of body keywords, title keywords, and comment keywords; and combining and de-duplicating the at least one of the body keywords, the title keywords, and the comment keywords to obtain the keyword of the news information.

Clause 6: The method of Clause 4 or 5, wherein calculating the respective degree of similarity between the news information and each resource category based on the keyword of the news information and the respective keyword of each resource category comprises: obtaining a word vector of the keyword of the news information and a word vector of the keyword of each resource category; and calculating the respective degree of similarity between the news information and each resource category based on the word vector of the keyword of the news information and the word vector of the keyword of each resource category.

Clause 7: The method of Clause 1, wherein obtaining the target news information that matches the target resource category comprises: calculating a degree of similarity between each piece of news information in a news corpus and the target resource category; and obtaining a piece of news information having a degree of similarity with the target resource category satisfying a second preset similarity condition to serve as the target news information.

Clause 8: The method of Clause 7, wherein calculating the degree of similarity between each piece of news information in the news corpus and the target resource category comprises: performing word segmentation on the target resource category to obtain a keyword of the target resource category; and for each piece of news information, obtaining a keyword of the respective piece of news information based on at least one type of information in a body, a title, and comment information of the respective piece of news information, and calculating a degree of similarity between the respective piece of news information and the target resource category based on the keyword of the respective piece of news information and the keyword of the target resource category.

Clause 9: The method of Clause 8, wherein calculating the degree of similarity between the respective piece of news information and the target resource category based on the keyword of the respective piece of news information and the keyword of the target resource category comprises: obtaining a word vector of the keyword of the respective piece of news information and a vector of the keyword of the target resource category; and calculating the degree of similarity between the respective piece of news information and the target resource category based on the word vector of the keyword of the respective piece of news information and the word vector of the keyword of the target resource category.

Clause 10: A data processing method comprising: capturing news information meeting a preset requirement from a network platform according to a preset capturing period; calculating a respective degree of similarity between the news information and each resource category in a resource category library; determining a resource category having a degree of similarity with the news information that meets a first preset similarity condition; and establishing a matching relationship between the news information and the resource category.

Clause 11: The method of Clause 10, wherein calculating the respective degree of similarity between the news information and each resource category in the resource category library comprises: obtaining a keyword of the news information according to at least one type of information in a body, a title, and comment information of the news information; performing word segmentation on each resource category to obtain a respective keyword for each resource category; and calculating the respective degree of similarity between the news information and each resource category based on the keyword of the news information and the respective keyword of each resource category.

Clause 12: The method of Clause 11, wherein obtaining the keyword of the news information according to the at least one type of information in the body, the title, and the comment information of the news information comprises: performing keyword extraction on the at least one type of information in the body, the title and the comment information of the news information to obtain at least one of body keywords, title keywords, and comment keywords; and combining and de-duplicating the at least one of the body keywords, the title keywords, and the comment keywords to obtain the keyword of the news information.

Clause 13: The method of Clause 11 or 12, wherein calculating the respective degree of similarity between the news information and each resource category based on the keyword of the news information and the respective keyword of each resource category comprises: obtaining a word vector of the keyword of the news information and a word vector of the keyword of each resource category; and calculating the respective degree of similarity between the news information and each resource category based on the word vector of the keyword of the news information and the word vector of the keyword of each resource category.

Clause 14: A service processing method comprising: capturing news information meeting a preset requirement from a network platform according to a preset capturing period; determining a target resource category that matches the news information; and performing service processing on a network resource under the target resource category.

Clause 15: The method of Clause 14, wherein determining the target resource category that matches the news information comprises: calculating a respective degree of similarity between the news information and each resource category in a resource category library; and determining a resource category having a degree of similarity with the news information that meets a first preset similarity condition as the target resource category.

Clause 16: The method of Clause 15, wherein calculating the respective degree of similarity between the news information and each resource category in the resource category library comprises: obtaining a keyword of the news information according to at least one type of information in a body, a title, and comment information of the news information; performing word segmentation on each resource category to obtain a respective keyword for each resource category; and calculating the respective degree of similarity between the news information and each resource category based on the keyword of the news information and the respective keyword of each resource category.

Clause 17: The method of Clause 16, wherein obtaining the keyword of the news information according to the at least one type of information in the body, the title, and the comment information of the news information comprises: performing keyword extraction on the at least one type of information in the body, the title and the comment information of the news information to obtain at least one of body keywords, title keywords, and comment keywords; and combining and de-duplicating the at least one of the body keywords, the title keywords, and the comment keywords to obtain the keyword of the news information.

Clause 18: The method of Clause 16 or 17, wherein calculating the respective degree of similarity between the news information and each resource category based on the keyword of the news information and the respective keyword of each resource category comprises: obtaining a word vector of the keyword of the news information and a word vector of the keyword of each resource category; and calculating the respective degree of similarity between the news information and each resource category based on the word vector of the keyword of the news information and the word vector of the keyword of each resource category.

Clause 19: A service processing apparatus comprising: a first determination module configured to determine a target resource category to which a network resource to be processed belongs; an acquisition module configured to obtain target news information that matches the target resource category; and a service module configured to perform service processing on the network resource to be processed according to the target news information.

Clause 20: The apparatus of Clause 19, wherein the acquisition module is specifically configured to query pre-established matching relationships between resource categories and news information based on the target resource category to obtain the target news information.

Clause 21: The apparatus of Clause 20, further comprising: a capturing module configured to capture news information meeting a preset requirement from a network platform according to a preset capturing period; a calculation module configured to calculate a respective degree of similarity between the news information and each resource category in a resource category library; a second determination module configured to determine a resource category having a degree of similarity with the news information that meets a first preset similarity condition; and an establishing module configured to establish a matching relationship between the news information and the determined resource category.

Clause 22: The apparatus of Clause 21, wherein the calculation module comprises: an acquisition unit configured to obtain a keyword of the news information according to at least one type of information in a body, a title, and comment information of the news information; a word segmentation unit configured to perform word segmentation on each resource category to obtain a respective keyword for each resource category; and a calculation unit configured to calculate the respective degree of similarity between the news information and each resource category based on the keyword of the news information and the respective keyword of each resource category.

Clause 23: The apparatus of Clause 22, wherein the acquisition unit is specifically configured to: perform keyword extraction on the at least one type of information in the body, the title and the comment information of the news information to obtain at least one of body keywords, title keywords, and comment keywords; and combine and de-duplicate the at least one of the body keywords, the title keywords, and the comment keywords to obtain the keyword of the news information.

Clause 24: The apparatus of Clause 22 or 23, wherein the calculation unit is specifically configured to: obtain a word vector of the keyword of the news information and a word vector of the keyword of each resource category; and calculate the respective degree of similarity between the news information and each resource category based on the word vector of the keyword of the news information and the word vector of the keyword of each resource category.

Clause 25: The apparatus of Clause 19, wherein the acquisition module is specifically configured to: calculate a degree of similarity between each piece of news information in a news corpus and the target resource category; and obtain a piece of news information having a degree of similarity with the target resource category satisfying a second preset similarity condition to serve as the target news information.

Clause 26: The apparatus of Clause 25, wherein the acquisition module is specifically configured to: perform word segmentation on the target resource category to obtain a keyword of the target resource category; and for each piece of news information, obtain a keyword of the respective piece of news information based on at least one type of information in a body, a title, and comment information of the respective piece of news information, and calculate a degree of similarity between the respective piece of news information and the target resource category based on the keyword of the respective piece of news information and the keyword of the target resource category.

Clause 27: The apparatus of Clause 27, wherein the acquisition module is specifically configured to: obtain a word vector of the keyword of the respective piece of news information and a vector of the keyword of the target resource category; and calculate the degree of similarity between the respective piece of news information and the target resource category based on the word vector of the keyword of the respective piece of news information and the word vector of the keyword of the target resource category.

Clause 28: A data processing apparatus comprising: a capturing module configured to capture news information meeting a preset requirement from a network platform according to a preset capturing period; a calculation module configured to calculate a respective degree of similarity between the news information and each resource category in a resource category library; a determination module configured to determine a resource category having a degree of similarity with the news information that meets a first preset similarity condition; and an establishing module configured to establish a matching relationship between the news information and the determined resource category.

Clause 29: The apparatus of Clause 28, wherein the calculation module comprises: an acquisition unit configured to obtain a keyword of the news information according to at least one type of information in a body, a title, and comment information of the news information; a word segmentation unit configured to perform word segmentation on each resource category to obtain a respective keyword for each resource category; and a calculation unit configured to calculate the respective degree of similarity between the news information and each resource category based on the keyword of the news information and the respective keyword of each resource category.

Clause 30: The apparatus of Clause 29, wherein the acquisition unit is specifically configured to: perform keyword extraction on the at least one type of information in the body, the title and the comment information of the news information to obtain at least one of body keywords, title keywords, and comment keywords; and combine and de-duplicate the at least one of the body keywords, the title keywords, and the comment keywords to obtain the keyword of the news information.

Clause 31: The apparatus of Clause 28 or 29, wherein the calculation unit is specifically configured to: obtain a word vector of the keyword of the news information and a word vector of the keyword of each resource category; and calculate the respective degree of similarity between the news information and each resource category based on the word vector of the keyword of the news information and the word vector of the keyword of each resource category.

Clause 32: A service processing apparatus comprising: a capturing module configured to capture news information meeting a preset requirement from a network platform according to a preset capturing period; a determination module configured to determine a target resource category that matches the news information; and a service module configured to perform service processing on a network resource under the target resource category.

Clause 33: The apparatus of Clause 32, wherein the determination module comprises: a calculation unit configured to calculate a respective degree of similarity between the news information and each resource category in a resource category library; and a determination unit configured to determine a resource category having a degree of similarity with the news information that meets a first preset similarity condition as the target resource category.

Clause 34: The apparatus of Clause 33, wherein the calculation unit is specifically configured to: obtain a keyword of the news information according to at least one type of information in a body, a title, and comment information of the news information; perform word segmentation on each resource category to obtain a respective keyword for each resource category; and calculate the respective degree of similarity between the news information and each resource category based on the keyword of the news information and the respective keyword of each resource category.

Clause 35: The apparatus of Clause 34, wherein the calculation unit is specifically configured to: perform keyword extraction on the at least one type of information in the body, the title and the comment information of the news information to obtain at least one of body keywords, title keywords, and comment keywords; and combine and de-duplicate the at least one of the body keywords, the title keywords, and the comment keywords to obtain the keyword of the news information.

Clause 36: The apparatus of Clause 34 or 35, wherein the calculation unit is specifically configured to: obtain a word vector of the keyword of the news information and a word vector of the keyword of each resource category; and calculate the respective degree of similarity between the news information and each resource category based on the word vector of the keyword of the news information and the word vector of the keyword of each resource category.

What is claimed is:

1. A method implemented by one or more computing devices, the method comprising:
determining a target resource category to which a network resource to be processed belongs;
obtaining target news information that matches the target resource category; and
performing service processing on the network resource to be processed according to the target news information.

2. The method of claim 1, wherein obtaining the target news information that matches the target resource category comprises querying pre-established matching relationships between resource categories and news information based on the target resource category to obtain the target news information.

3. The method of claim 2, wherein establishing the matching relationships between resource categories and news information comprises:
capturing news information meeting a preset requirement from a network platform according to a preset capturing period;
calculating a respective degree of similarity between the news information and each resource category in a resource category library;
determining a resource category having a degree of similarity with the news information that meets a first preset similarity condition; and
establishing a matching relationship between the news information and the resource category.

4. The method of claim 3, wherein calculating the respective degree of similarity between the news information and each resource category in the resource category library comprises:
obtaining a keyword of the news information according to at least one type of information in a body, a title, and comment information of the news information;
performing word segmentation on each resource category to obtain a respective keyword for each resource category; and
calculating the respective degree of similarity between the news information and each resource category based on the keyword of the news information and the respective keyword of each resource category.

5. The method of claim 4, wherein obtaining the keyword of the news information according to the at least one type of information in the body, the title, and the comment information of the news information comprises:
performing keyword extraction on the at least one type of information in the body, the title and the comment information of the news information to obtain at least one of body keywords, title keywords, and comment keywords; and
combining and de-duplicating the at least one of the body keywords, the title keywords, and the comment keywords to obtain the keyword of the news information.

6. The method of claim 4, wherein calculating the respective degree of similarity between the news information and each resource category based on the keyword of the news information and the respective keyword of each resource category comprises:
obtaining a word vector of the keyword of the news information and a word vector of the keyword of each resource category; and
calculating the respective degree of similarity between the news information and each resource category based on the word vector of the keyword of the news information and the word vector of the keyword of each resource category.

7. The method of claim 1, wherein obtaining the target news information that matches the target resource category comprises:
calculating a degree of similarity between each piece of news information in a news corpus and the target resource category; and
obtaining a piece of news information having a degree of similarity with the target resource category satisfying a second preset similarity condition to serve as the target news information.

8. The method of claim 7, wherein calculating the degree of similarity between each piece of news information in the news corpus and the target resource category comprises:
performing word segmentation on the target resource category to obtain a keyword of the target resource category; and
for each piece of news information, obtaining a keyword of the respective piece of news information based on at least one type of information in a body, a title, and comment information of the respective piece of news information, and calculating a degree of similarity between the respective piece of news information and the target resource category based on the keyword of the respective piece of news information and the keyword of the target resource category.

9. The method of claim 8, wherein calculating the degree of similarity between the respective piece of news information and the target resource category based on the keyword of the respective piece of news information and the keyword of the target resource category comprises:
obtaining a word vector of the keyword of the respective piece of news information and a vector of the keyword of the target resource category; and
calculating the degree of similarity between the respective piece of news information and the target resource category based on the word vector of the keyword of the respective piece of news information and the word vector of the keyword of the target resource category.

10. An apparatus comprising:
one or more processors;
memory;
a capturing module stored in the memory and executable by the one or more processors to capture news information meeting a preset requirement from a network platform according to a preset capturing period;
a calculation module stored in the memory and executable by the one or more processors to calculate a respective degree of similarity between the news information and each resource category in a resource category library;
a determination module stored in the memory and executable by the one or more processors to determine a resource category having a degree of similarity with the news information that meets a first preset similarity condition; and
an establishing module stored in the memory and executable by the one or more processors to establish a matching relationship between the news information and the determined resource category.

11. The apparatus of claim 10, wherein the calculation module comprises:
an acquisition unit configured to obtain a keyword of the news information according to at least one type of information in a body, a title, and comment information of the news information;
a word segmentation unit configured to perform word segmentation on each resource category to obtain a respective keyword for each resource category; and
a calculation unit configured to calculate the respective degree of similarity between the news information and each resource category based on the keyword of the news information and the respective keyword of each resource category.

12. The apparatus of claim 11, wherein the acquisition unit is further configured to:
perform keyword extraction on the at least one type of information in the body, the title and the comment information of the news information to obtain at least one of body keywords, title keywords, and comment keywords; and
combine and de-duplicate the at least one of the body keywords, the title keywords, and the comment keywords to obtain the keyword of the news information.

13. The apparatus of claim 10, wherein the calculation unit is further configured to:
obtain a word vector of the keyword of the news information and a word vector of the keyword of each resource category; and
calculate the respective degree of similarity between the news information and each resource category based on the word vector of the keyword of the news information and the word vector of the keyword of each resource category.

14. One or more computer readable media storing executable instructions that, when executed by one or more processors, cause the one or more processors to perform acts comprising:
capturing news information meeting a preset requirement from a network platform according to a preset capturing period;
determining a target resource category that matches the news information; and
performing service processing on a network resource under the target resource category.

15. The one or more computer readable media of claim 14, wherein determining the target resource category that matches the news information comprises:
calculating a respective degree of similarity between the news information and each resource category in a resource category library; and
determining a resource category having a degree of similarity with the news information that meets a first preset similarity condition as the target resource category.

16. The one or more computer readable media of claim 15, wherein calculating the respective degree of similarity between the news information and each resource category in the resource category library comprises:
obtaining a keyword of the news information according to at least one type of information in a body, a title, and comment information of the news information;
performing word segmentation on each resource category to obtain a respective keyword for each resource category; and
calculating the respective degree of similarity between the news information and each resource category based on the keyword of the news information and the respective keyword of each resource category.

17. The one or more computer readable media of claim 16, wherein obtaining the keyword of the news information according to the at least one type of information in the body, the title, and the comment information of the news information comprises:
performing keyword extraction on the at least one type of information in the body, the title and the comment information of the news information to obtain at least one of body keywords, title keywords, and comment keywords; and
combining and de-duplicating the at least one of the body keywords, the title keywords, and the comment keywords to obtain the keyword of the news information.

18. The one or more computer readable media of claim 16, wherein calculating the respective degree of similarity between the news information and each resource category based on the keyword of the news information and the respective keyword of each resource category comprises:
obtaining a word vector of the keyword of the news information and a word vector of the keyword of each resource category; and
calculating the respective degree of similarity between the news information and each resource category based on the word vector of the keyword of the news information and the word vector of the keyword of each resource category.

19. The one or more computer readable media of claim 14, wherein the target resource category comprises a product category, and the network resources comprises one or more products under the product category.

20. The one or more computer readable media of claim 14, wherein the preset requirement comprises at least one of a degree of popularity being greater than a specified popularity threshold, or a time of occurrence being later than a specified time.
